(19) United States
(12) Patent Application Publication
(10) Pub. No.: US 2025/0174839 A1
(43) Pub. Date: May 29, 2025

(54) BATTERY ASSEMBLY WITH OVERLAPPING POUCH CELLS

(71) Applicant: Porsche eBike Performance GmbH, Ottobrunn (DE)

(72) Inventors: David Köhler, Sachsenheim (DE); Tim Schmidt, Freiberg am Neckar (DE)

(21) Appl. No.: 18/960,267

(22) Filed: Nov. 26, 2024

(30) Foreign Application Priority Data
Nov. 28, 2023 (DE) 102023133226.0

(51) Int. Cl. H01M 50/519; H01M 50/211

(52) U.S. Cl. CPC H01M 50/519; H01M 50/211

(57) ABSTRACT

In an embodiment a battery assembly includes a first package having at least one pouch cell and a second package having at least one pouch cell, wherein the first package and the second package with respective electrodes of the pouch cells are arranged facing one another, and wherein the pouch cells of the opposite packages overlap in an overlapping area.

### CROSS-REFERENCE TO RELATED APPLICATIONS

This application claims priority to German application no. 10 2023 133 226.0, filed on Nov. 28, 2023, which application is hereby incorporated herein by reference.

TECHNICAL FIELD

The invention relates to a battery assembly. The invention further relates to a method for producing a battery assembly. Moreover, the invention relates to a battery assembly with pouch cells.

### BACKGROUND

Pouch cells are well known from prior art. Pouch cells are a specific type of accumulator, in particular, a lithium-ion battery.

Pouch cells usually comprise a plate-shaped or flat, cuboid geometry. The dimensions of the base surface of the pouch cell are usually larger than the height of the pouch cell. Pouch cells usually comprise a plurality of rectangular or cuboid layers. One layer forms the anode and one layer the cathode. The anode and cathode are separated from one another by a separating layer. The outer wrapping of the pouch cell is usually formed by a flexible wrapping. The anode and cathode are led out to one side via electrodes so that the electrodes project from the wrapping. The electrodes are often made of copper or aluminum foil and are easily deformable.

The advantage of pouch cells is that they can be stacked well due to their cuboid geometry. Particularly in often rectangular housings—as is common in both the automotive sector as well as the e-bike sector-pouch cells can fill the available space with a higher density than is possible with round cells.

Pouch cells can be used for various applications, in particular, as drive energy storage for electric bicycles as well as for drive energy storage for electric vehicles. In order to provide sufficient drive power, a plurality of pouch cells is usually electrically connected to one another in series.

### SUMMARY

Embodiments provide a battery assembly as well as a method for producing a battery assembly that enables a space-saving and stable electrical connection of the pouch cells.

A battery assembly according to embodiments of the invention comprises a first package of at least one pouch cell and a second package of at least one pouch cell. A package is a stack of one or a plurality of pouch cells, wherein the pouch cells each comprise the same orientation. If there are a plurality of pouch cells, a package then includes pouch cells stacked on top of one another and aligned in the same way. In particular, at least two, preferably six or seven or even more pouch cells can be stacked on top of one another. If a package comprises a plurality of pouch cells, they are stacked on top of one another in such a way that they rest on top of one another with their base surface.

The first package and the second package are arranged in such a way that the respective electrodes of the pouch cells of the first package and the pouch cells of the second package are arranged facing one another. In particular, two packages of pouch cells with their short front sides on which the electrodes project are arranged facing one another.

The pouch cells are also arranged in such a way that the opposite packages overlap in an overlapping area. In other words, the packets project into one another for at least part of their length or the length of the pouch cells. The pouch cells of different packages are spaced apart from one another in the overlapping area and do not touch one another. The pouch cells overlap when projected onto the base surface of the pouch cells.

The overlapping assembly of at least two packages results in a particularly space-saving assembly of a plurality of pouch cells. The distance between the two packages is reduced, thereby reducing the overall length of the battery assembly.

In particular, the overlapping area in which the pouch cells of opposing packages overlap extends at least over the electrodes that project with respect to the wrapping. In particular, the overlapping area also extends over part of the wrapping, in particular, up to or even beyond the area of a sealed seam.

In particular, the electrodes of the first package and the electrodes of the second package are electrically connected to one another via a common flexible printed circuit board (also known as a flex PCB). The electrical printed circuit board is arranged in an accordion-like manner or accordion folded to connect the electrodes. This means that the flexible printed circuit board winds in an S-shape in the area between the first package and the second package. The flexible printed circuit board winds in a plurality of layers, each of which merges into one another via a bend or a curve/radius. As also becomes clear in connection with the method, the accordion-shaped arrangement of the flexible printed circuit board makes it possible to connect the pouch cells even if the pouch cells of the two packages overlap in a projection, and, in particular, overlap in the area of the electrodes. The flexible printed circuit board can thus connect all the electrodes of the battery assembly with one another consistently and stably.

In particular, the flexible printed circuit board comprises a conductor path that serves to conduct the main current and via which all cathodes and anodes are connected. In particular, the flexible printed circuit board also comprises an additional conductor path per pouch cell in order to enable voltage tapping for each pouch cell to evaluate the cell voltage.

In particular, the electrodes are connected to the flexible printed circuit board in a material-tight manner, in particular, welded to the printed circuit board so that there is a stable connection between the electrodes and the printed circuit board.

In particular, the flexible printed circuit board alternately connects a pouch cell of the first package and a pouch cell of the second package. With regard to series connection, this means that pouch cells of the first package and the second package are alternately connected in series. In particular, the flexible printed circuit board in the longitudinal direction of the printed circuit board connects the electrodes in the following sequential order:
a first electrode of a first pouch cell of the first package,
a second electrode of the first pouch cell of the first package,
a first electrode of the first pouch cell of the second package, and then
a second electrode of the first pouch cell of the second package.

If the packets comprise other pouch cells, the connection is continued in the same way:
a first electrode of a second pouch cell of the first package,
a second electrode of the second pouch cell of the first package,
a first electrode of the second pouch cell of the second package, and then
a second electrode of the second pouch cell of the second package.

In particular, the battery assembly comprises a centre line that extends midway between the two packages. The centre line runs halfway along the total length of the battery assembly. In particular, the individual pouch cells are arranged in such a way that electrodes of the pouch cells project beyond the centre line so that at least the electrodes of a respective package and part of the remaining package are each arranged on different sides of the centre line. In particular, the electrodes project beyond the centre line. In particular, the electrodes of the different packages do not overlap, but the electrodes overlap with part of the wrapping of the pouch cells of the other package.

In particular, the printed circuit board comprises contacts for contacting the individual electrodes, wherein in each case two contacts are electrically conductively connected. In particular, a conductor path is formed between each two contacts. In particular, an anode of a first pouch cell of a package and a cathode of a second pouch cell of the other package are connected to one another. The connected contacts are arranged with respect to a printed-circuit-board centre line, which extends in the longitudinal direction of the printed circuit board so that the connected contacts are on opposite sides of the conductor-path centre line. In particular, the centre line of the battery assembly also corresponds to the printed-circuit-board centre line.

In addition to saving installation space, the staggered assembly of the electrodes and corresponding contacts has the advantage that in an accordion folded flexible printed circuit board, the unconnected contacts, which are located in two folded layers, are spaced from one another in a transverse direction of the printed circuit board. In the event that the printed circuit board is compressed so strongly that the layers come to the system, the non-connected contacts would not touch one another.

In particular, at least one pouch cell of the first package and at least one pouch cell of the second package are arranged at different heights. The vertical direction corresponds to the direction in which a plurality of pouch cells is stacked on top of one another. One pouch cell is connected to one layer of the printed circuit board, which is accordion folded, in particular, with its electrodes, and after the bend or curve, another pouch cell is connected to the next layer.

In order to enable easy connection of the electrodes with the flexible printed circuit board, the pouch cells are arranged in such a way that the electrodes of the first package and the second package have opposite polarities.

In addition, or as an alternative, the electrodes of pouch cells arranged on top of one another within a package each comprise the same polarity.

If an electrode of the first package is arranged at a first layer of the accordion folded printed circuit board, then after the ‘curve’, the opposite electrode of the second package can be contacted with the next layer with a different polarity, etc.

Embodiments of the invention also relates to a method for producing a battery assembly having two opposing packages of pouch cells, in particular, a battery assembly as described above.

In a first step, pouch cells of the first package are arranged in a first row and pouch cells of the second package are arranged in a second row. The electrodes of the pouch cells of the first row and the electrodes of the pouch cells of the second row point towards one another. The pouch cells of the first row and the pouch cells of the second row are spaced apart from one another, and in the gap between two adjacent pouch cells of a row a pouch cell of the other row is placed so that the pouch cells of the two rows overlap in an overlapping area. The electrodes of the different packages are then not in line with one another, but on opposite sides of the centre line.

The electrodes are then electrically connected to one another and the rows are folded into packages.

Due to the alternating assembly of pouch cells and their overlapping, the pouch cells can be easily contacted and folded into a space-saving assembly. For the benefits and other details, please refer to the description above.

Contacting can be particularly easy if the pouch cells are arranged in such a way that the electrodes of two pouch cells of different packages, which are adjacent to one another, comprise an opposite polarity.

In particular, the electrodes of all pouch cells are connected in turn by means of a flexible printed circuit board, and at a next step, the pouch cells are folded together with the flexible printed circuit board in an accordion-like manner. In the spread out state of the pouch cells, which are still laid out in rows, the electrodes are easily accessible and the connection to the flexible printed circuit board is easily possible. Afterwards the folding and production of the individual packages is performed.

### BRIEF DESCRIPTION OF THE DRAWINGS

Other practical embodiments and advantages are described in connection with the figures.

FIG. 1 shows a battery assembly with a first package of pouch cells and a second package of pouch cells in an oblique lateral perspective view;

FIG. 2 shows a section of the battery assembly in accordance with FIG. 1 in detail in an oblique lateral perspective view;

FIG. 3 shows an assembly of a plurality of pouch cells in two rows in accordance with a first method step;

FIG. 4 shows the assembly from FIG. 3 with a flexible printed circuit board in accordance with a second method step;

FIG. 5 shows the assembly of FIG. 3 and FIG. 4 partially folded up;

FIG. 6 shows the assembly from FIGS. 3, 4 and 5 folded up further; and

FIG. 7 shows a flexible printed circuit board in a schematic illustration in a top view.

### DETAILED DESCRIPTION OF ILLUSTRATIVE EMBODIMENTS

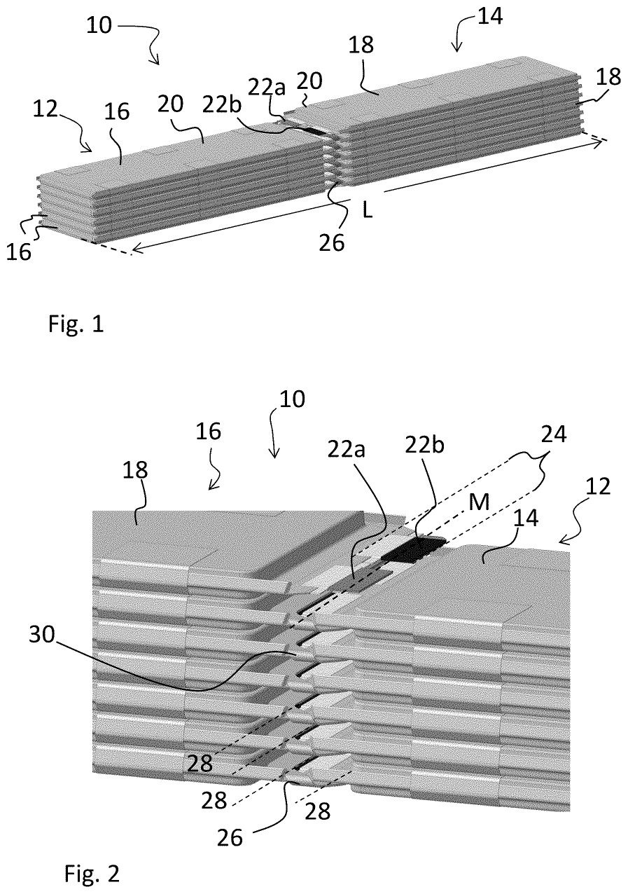

FIG. 1 and FIG. 2 show a battery assembly 10. The battery assembly 10 comprises a first package 12 with six pouch cells 14 in the present case and a second package 16 with seven pouch cells 18 in the present case. The pouch cells 14, 18 of a package 12, 16 are stacked on top of one another and comprise the same orientation.

The pouch cells comprise a wrapping 20, and electrodes 22a, 22b project from the wrapping 20, respectively, to contact the anode or cathode of a pouch cell 14, 18. Pouch cells 14, 18 comprise a rectangular base surface and electrodes 22a, 22b project from a short front of pouch cells 14, 18.

The first package 12 and the second package 16 are arranged in such a way that the electrodes 22a, 22b of the respective pouch cells 14, 18 are facing one another. The pouch cells 14, 18 of the two packages are further arranged in such a way that the pouch cells 14, 18 overlap in an overlapping area 24 (cf. FIG. 3). The pouch cells 14, 18 are arranged into one another in such a way that the total length L of the battery assembly 10 is less than the sum of the lengths of the individual packages 12, 16.

The battery assembly 10 comprises a centre line M that lies at the half of the total length L. The pouch cells 14, 18 of the two packages 12, 16 are pushed into one another to such an extent that the majority of a package 12, 16 lies on one side of the centre line M, but the electrodes 22a, 22b of the respective package 12, 16 are completely on the other side of the centre line M. The overlapping area 24 extends across more than the length of electrodes 22a, 22b, which is projecting with relation to the wrapping 20.

Pouch cells 14, 18 are all connected to one another via a flexible printed circuit board 26. The flexible printed circuit board 26 extends in the area between the two packages 12, 16. The flexible printed circuit board 26 extends here in the form of an accordion in order to electrically connect the individual pouch cells 14, 18 arranged on top of one another and the electrodes 22a, 22b of the individual pouch cells 14, 18. This means that the flexible printed circuit board 28 comprises a plurality of layers 28, which extend at different height levels, wherein the layers 28 arranged on top of one another merge into one another via a bend or a curve 30. The electrodes 22a, 22b of a pouch cell 14, 18 are connected to a layer 28 of the flexible, accordion folded flexible printed circuit board 26.

The flexible printed circuit board 26 alternately connects the pouch cells 14 of the first package 12 and the pouch cells 18 of the second package 16.

Pouch cells 14, 18 are arranged in such a way that within a package 12, 16 electrodes 22a, 22b, which are arranged exactly on top of one another, comprise the same polarity. The opposite electrodes 22a, 22b of the different packages 12, 16 comprise an opposite polarity.

There is a height offset between pouch cells 14 of the first package 12 and the pouch cells 18 of the second package 16. As described above, by folding the flexible printed circuit board 28, each pouch cell 14, 18 is arranged at a different height level.

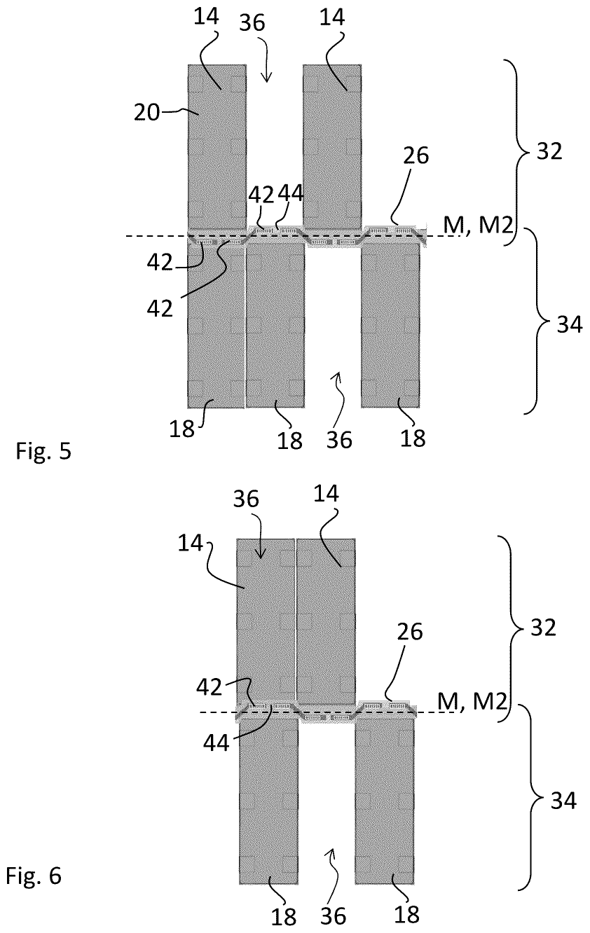

In conjunction with FIGS. 3 to 7, in the following a method for making a battery assembly 10 in accordance with FIGS. 1 and 2 is described.

FIG. 3 shows a first step of the method. A first row 32 with pouch cells 14 and a second row 34 with pouch cells 18 are formed. The first row 32 subsequently forms the first package 12 and the second row 34 the second package 16. In the present case, only two pouch cells 14 are shown in the first row 32 and only three pouch cells 18 in the second row 34. Rows 32, 34 may also comprise more pouch cells 14, 18, depending on how many pouch cells 14, 18 subsequently form a package 12, 16.

Pouch cells 14, 18 are arranged in such a way that pouch cells 14, 18 of the different rows 32, 34 each point towards one another with electrodes 22a, 22b.

Rows 32, 34 are formed in such a way that a gap 36 is formed between adjacent pouch cells 14, 18 in a row 32, 34 and the pouch cell 14, 18 of the other row 34, 32 is arranged projecting into it. The distance between two pouch cells 14 or 18 is dimensioned in such a way that exactly one pouch cell 14, 18 of a row 32, 34 fits between two pouch cells 18, 14 of the other row 34, 32.

Pouch cells 14, 18 are arranged in such a way that pouch cells 14 of the first row 32 and pouch cells 18 of the second row 34 overlap in an overlapping area 24. The overlapping area 24 extends over the respective electrodes 22a, 22b and additionally over a section of the wrapping 24.

As can be clearly seen in FIG. 3, the electrodes 22a, 22b each extend from a row 32, 34 to beyond the centre line M. The electrodes 22aa, 2bb of the first row 32 are offset with respect to the centre line M to the electrodes 22a, 22b of the second row 34.

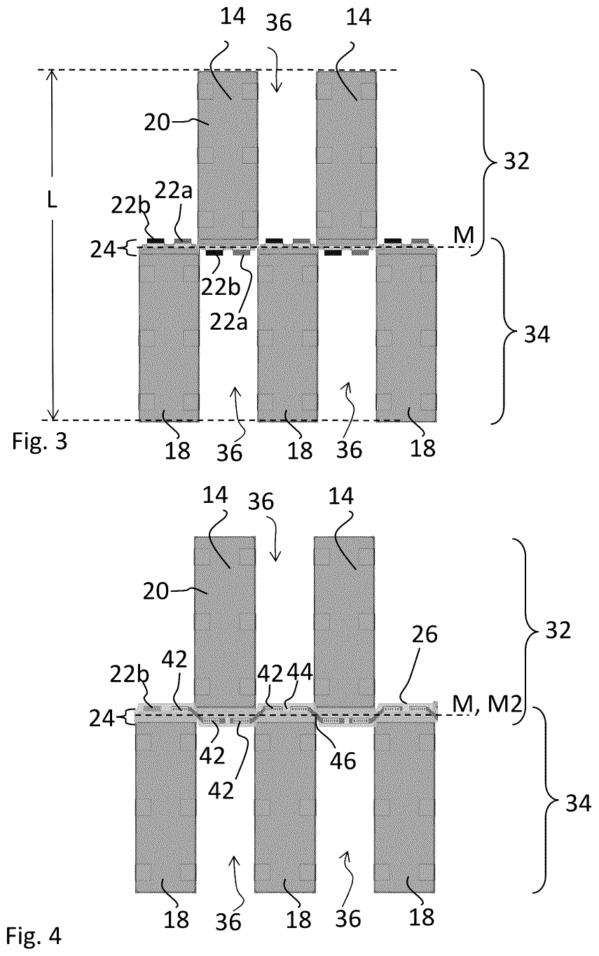

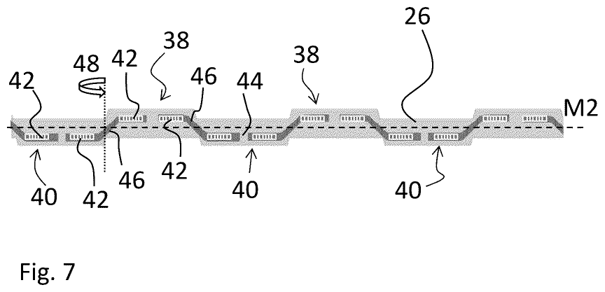

After providing the first row 32 and the second row 34, the next step, which is shown in conjunction with FIG. 4 and FIG. 7, is to arrange the flexible printed circuit board 26 on the pouch cells 14, 18 and connect it to the electrodes 22a, 22b.

The flexible printed circuit board 26 is shown in detail in FIG. 7. The flexible printed circuit board 26 comprises alternating first sections 38 and second sections 40, which are staggered with respect to a printed-circuit-board centre line M2. The first sections 38 are used to contact the electrodes 22a, 22b of the first row 32 and the second sections 40 are used to contact the electrodes 22a, 22b of the second row 34. Overall, the flexible printed circuit board 28 comprises a double-cranked geometry on both long sides.

The flexible printed circuit board 28 comprises contacts 42 for contacting the individual electrodes 22a, 22b, wherein a contact 42 in a first section 38 is conductively connected to a contact 42 in a second section 40 by means of a conductor path 46, wherein the conductively connected contacts 42 are each located on different sides of the printed-circuit-board centre line M2. An electrically insulating section 44 is formed between two contacts 42 connected via a conductor path 46 and the contacts 42 are then electrically connected to one another via a corresponding pouch cell 14, 18.

The flexible printed circuit board 26 is laid over the pouch cells 14, 18 laid out in rows 32, 34 and the assembly of contacts 42 makes the interconnection in such a way that pouch cells 14 of the first row 32 and pouch cells 18 of the second row 34 are alternately connected in series (see FIG. 4). The contacts 42 are welded to electrodes 22a, 22b. The centre line M of the battery assembly and the printed-circuit-board centre line M2 then coincide.

In connection with FIGS. 4 to 6, the folding of the pouch cells 14, 18 arranged in rows 32, 34 into packages 12, 16 is now explained.

In the example shown, the first pouch cell 18 at the end of the second row 34 is folded onto the row 34 itself so that a first layer 28 is established. A layer 28 corresponds to a section 38, 40. Then the folded layer 28 is folded from the top to rows 32, 34 and the next layer 28 is established. In FIG. 7, in which the printed circuit board 26 is shown, arrow 48 is used to visualize a curve 30 between two layers 28. In total, rows 32, 34 are folded with printed circuit board 26 to form an accordion folded structure. Pouch cells 14, 18 of a row 32, 34 then lie on top of one another and form a package 12, 16.

The flexible printed circuit board 26 comprises one layer 28 per fold, wherein in a layer 28-which extends at a height level-the electrodes 22a, 22b of a pouch cell 14, 18 are contacted. The connected contacts 42 each extend over a curve 30 from one layer 28 to a next layer 28. Non-connected contacts 42 in different layers 28 do not touch one another due to the offset of sections 38, 40 even if layers 28 touch one another.

What is claimed is:

1. A battery assembly comprising:
a first package comprising at least one pouch cell and a second package comprising at least one pouch cell,
wherein the first package and the second package with respective electrodes of the pouch cells are arranged facing one another, and
wherein the pouch cells of the opposite packages overlap in an overlapping area.

2. The battery assembly according to claim 1,
wherein the electrodes of the first package and the electrodes of the second package are electrically connected via a common flexible printed circuit board, and
wherein the flexible printed circuit board is accordion folded.

3. The battery assembly according to claim 2,
wherein the flexible printed circuit board alternately connects a pouch cell of the first package and a pouch cell of the second package.

4. The battery assembly according to claim 1, wherein the battery assembly comprises a centre line, which runs in the middle of the two packages between the packages,
wherein the electrodes of the pouch cells project beyond the centre line so that the electrodes of a respective package and part of a corresponding remaining package are arranged on different sides of the centre line.

5. The battery assembly according to claim 2,
wherein the printed circuit board comprises contacts configured for contacting the individual electrodes,
wherein two contacts are electrically conductively connected in each case, and
wherein the connected contacts are arranged with respect to a printed-circuit-board centre line such that the connected contacts lie on opposite sides of the printed-circuit-board centre line.

6. The battery assembly according to claim 2,
wherein the electrodes of a respective pouch cell are connected to a layer of the accordion folded printed circuit board.

7. The battery assembly according to claim 1,
wherein the pouch cells are arranged such that the electrodes of the first package and the second package have opposite polarities and/or that the electrodes arranged on top of one another within a package, each comprise the same polarity.

8. A method for producing a battery assembly with two opposing packages, each with at least one pouch cell, the method comprising:
arranging, at a first step, pouch cells in a first row to form a first package;
arranging, at a second step, pouch cells in a second row to form a second package,
wherein electrodes of the pouch cells of the first row and the electrodes of the pouch cells of the second row point towards one another,
wherein the pouch cells of the first row and the pouch cells of the second row are spaced apart from one another, and
wherein, in a gap between two adjacent pouch cells of each row, a pouch cell of the other row is arranged projecting into each row so that the pouch cells of the two rows overlap in an overlapping area;
electrically connecting, in a third step, the electrodes to one another; and
folding the rows into packages.

9. The method according to claim 8,
wherein the pouch cells are arranged such that the electrodes of two pouch cells of different packages, which are adjacent to one another, comprise opposite polarity.

10. The method according to claim 8,
wherein the electrodes of all pouch cells are connected in sequence by a flexible printed circuit board, and
wherein, in a further step, the pouch cells together with the flexible printed circuit board are folded in an accordion-like manner.
